(19) United States
(12) Patent Application Publication
(10) Pub. No.: US 2025/0076563 A1
(43) Pub. Date: Mar. 6, 2025

(54) CASTING FABRICATION OF REFLECTIVE POLYMER WAVEGUIDE

(71) Applicant: GOOGLE LLC, Mountain View, CA (US)

(72) Inventors: Kang Luo, San Jose, CA (US); Thomas Mercier, Weston, FL (US); Christophe Peroz, Zurich (CH)

(21) Appl. No.: 18/810,012

(22) Filed: Aug. 20, 2024

Related U.S. Application Data
(60) Provisional application No. 63/535,697, filed on Aug. 31, 2023.

(51) Int. Cl. F21V 8/00; G02B 6/36

(52) U.S. Cl. CPC G02B 6/0055; G02B 6/0053; G02B 6/3696

(57) ABSTRACT

A fabrication process uses casting to form portions of a waveguide having ultra-flat surfaces. A casting resin is coated between a prism mold and a top flat mold via inkjet, slot die, spray coating, etc. The top flat mold is lowered to conform with the casting resin and the casting resin is then cured to form a bottom prism array. After curing, the bottom prism array is demolded from the prism mold and the top flat mold is used as a carrier wafer to support the bottom prism array. The bottom prism array is selectively coated with a reflective coating and a second casting process is performed by coating the bottom prism array with casting resin to form a reflective waveguide.

### BACKGROUND

Reflective waveguides can enable high efficiency, uniform augmented reality display with limited artifacts (low eye glow, low rainbow, etc.). Current polymer reflective waveguide fabrication processes use an injection pressure molding process to fabricate separate prism arrays using thermoplastic material. A reflector is coated on one of the prism arrays, and the separate prism arrays are bonded together using a glue bonding process. Waveguide augmented display requires ultra-high flatness and parallelism, which is challenging for the injection molding process and subsequent bonding process.

### BRIEF DESCRIPTION OF THE DRAWINGS

The present disclosure may be better understood, and its numerous features and advantages made apparent to those skilled in the art by referencing the accompanying drawings. The use of the same reference symbols in different drawings indicates similar or identical items.

FIG. 1 is a diagram illustrating a rear perspective view of an augmented reality display device implementing casted reflective waveguide portions in accordance with some embodiments.

FIG. 2 is a diagram illustrating a cross-section view of an example implementation of a waveguide in accordance with some embodiments.

FIG. 3 is a diagram illustrating a reflective waveguide with two-dimensional pupil expansion geometry.

FIG. 4 is a diagram illustrating ideal waveguide geometry in contrast to defects that can occur with injection molded reflective waveguides.

FIG. 5 is a diagram illustrating a process for casting portions of a waveguide in accordance with some embodiments.

FIGS. 6A-B together are a diagram illustrating consecutive casting processes for fabricating a waveguide using a top flat mold as a carrier wafer in accordance with some embodiments.

FIGS. 7A-C together illustrate a process for implementing various different optical components on one waveguide using multiple consecutive casting steps in accordance with some embodiments.

FIG. 8 is a diagram illustrating a Mosaic casting mold and process in accordance with some embodiments.

FIG. 9 is a diagram of a process flow to fabricate vertically stacked prism arrays in accordance with some embodiments.

FIG. 10 is a diagram illustrating differences between an ideal waveguide and a fabricated waveguide, and a method of compensating for the differences in accordance with some embodiments.

FIG. 11 is a diagram of a process flow to correct a center-to-edge peak-to-valley error using a casting process in accordance with some embodiments.

FIG. 12 is a diagram illustrating a process to correct an echo/ripple error using a casting process in accordance with some embodiments.

### DETAILED DESCRIPTION

Embodiments described herein include techniques for fabricating a polymer reflective waveguide with high structural quality control (flatness, alignment, dimensions) and high precision and groove parallelism for high optical quality by using a casting process. The techniques described herein can be performed with a carrier wafer and utilize a semiconductor wafer process. In some embodiments, the polymer reflective waveguide is fabricated using two consecutive casting processes without the need for a bonding process. In some embodiments, the polymer reflective waveguide is fabricated using thermoset polymers having a large range of refractive index materials up to approximately 1.8, which can provide a larger field of view (FOV) for an augmented reality (AR) waveguide and superior mechanical properties. Reflective waveguides can provide small form factor AR displays with high efficiency and uniform display quality.

The techniques described herein can be used to mass-produce high-precision, ultra flat waveguides using a Mosaic mold and casting processes. In some embodiments, the techniques described herein are used to produce stacked waveguide optical structures that significantly reduce the form factor of a finished waveguide. In addition, techniques described herein can be used to correct defects such as variations in local thickness of a waveguide to produce ultra flat waveguides.

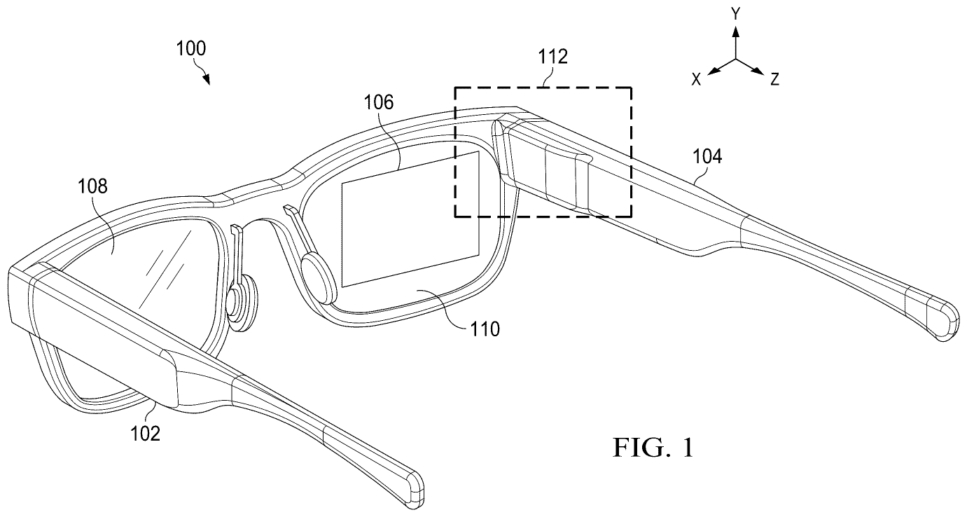

FIG. 1 illustrates an example AR eyewear display system 100 implementing a reflective waveguide formed by casting portions of the waveguide to each other without an adhesive layer in accordance with some embodiments. The AR eyewear display system 100 includes a support structure 102 (e.g., a support frame) to mount to a head of a user and that includes an arm 104 that houses a laser projection system, micro-display (e.g., micro-light emitting diode (LED) display), or other light engine configured to project display light representative of images toward the eye of a user, such that the user perceives the projected display light as a sequence of images displayed in a field of view (FOV) area 106 at one or both of lens elements 108, 110 supported by the support structure 102. In some embodiments, the support structure 102 further includes various sensors, such as one or more front-facing cameras, rear-facing cameras, other light sensors, motion sensors, accelerometers, and the like. The support structure 102 further can include one or more radio frequency (RF) interfaces or other wireless interfaces, such as a Bluetooth™ interface, a WiFi interface, and the like.

The support structure 102 further can include one or more batteries or other portable power sources for supplying power to the electrical components of the AR eyewear display system 100. In some embodiments, some or all of these components of the AR eyewear display system 100 are fully or partially contained within an inner volume of support structure 102, such as within the arm 104 in region 112 of the support structure 102. In the illustrated implementation, the AR eyewear display system 100 utilizes an eyeglasses form factor. However, the AR eyewear display system 100 is not limited to this form factor and thus may have a different shape and appearance from the eyeglasses frame depicted in FIG. 1.

One or both of the lens elements 108, 110 are used by the AR eyewear display system 100 to provide an AR display in which rendered graphical content can be superimposed over or otherwise provided in conjunction with a real-world view as perceived by the user through the lens elements 108, 110. For example, laser light or other display light is used to form a perceptible image or series of images that are projected onto the eye of the user via one or more optical elements, including a waveguide, formed at least partially in the corresponding lens element. One or both of the lens elements 108, 110 thus includes at least a portion of a waveguide that routes display light received by an input coupler (also referred to herein as an IC or incoupler) (not shown in FIG. 1) of the waveguide to an output coupler (also referred to herein as an OC or outcoupler) (not shown in FIG. 1) of the waveguide, which outputs the display light toward an eye of a user of the AR eyewear display system 100. Additionally, the waveguide employs an exit pupil expander (EPE) (not shown in FIG. 1) in the light path between the IC and OC, or in combination with the OC, in order to increase the dimensions of the display exit pupil. Each of the lens elements 108, 110 is sufficiently transparent to allow a user to see through the lens elements to provide a field of view of the user's real-world environment such that the image appears superimposed over at least a portion of the real-world environment.

To allow for a smaller, more compact form-factor, in some embodiments, one or more of the IC, OC, and/or EPE use reflective waveguide facets either to reflect light from one surface of the waveguide back to the same surface or to allow light to travel through the facets from one surface of the waveguide to a different, opposing surface of the waveguide. In order to bond portions of the reflective polymer waveguide to each other, conventional techniques impose stringent index matching adhesive requirements. For example, the larger the difference between the refractive index of the adhesive and the refractive index of the waveguide materials, the thinner the adhesive layer must be. In addition, the thickness of the adhesive layer must be uniform across the waveguide grating. Further, the processes for aligned bonding are relatively complicated. By contrast, using the techniques described herein, in some embodiments portions of the reflective waveguide are bonded directly to each other without the use of an interfacial index matching adhesive layer. Instead, materials used to form the portions of the reflective waveguide are casted to fuse the portions to each other. The casting processes described herein additionally prevent or remedy deformities associated with an injection molding process, such as ripple and echo effects.

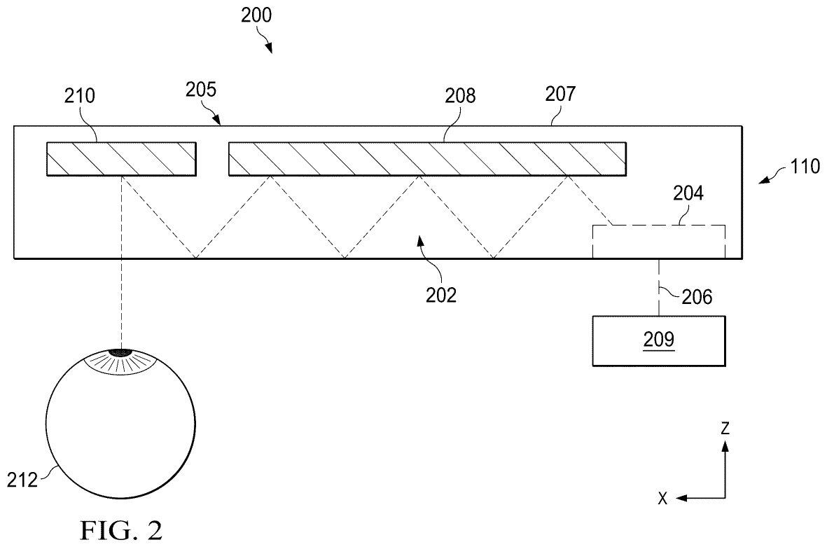

FIG. 2 depicts a cross-section view of an implementation of a display system 200 partially included in a lens element such as lens element 110 of an AR eyewear display system such as AR eyewear display system 100, which in some embodiments comprises a waveguide 202. Note that for purposes of illustration, at least some dimensions in the Z direction are exaggerated for improved visibility of the represented aspects.

The waveguide 202 includes an incoupler 204 and an outcoupler 210. The term “waveguide,” as used herein, will be understood to mean a combiner using one or more of total internal reflection (TIR), specialized filters, and/or reflective surfaces, to transfer light from an incoupler (such as the incoupler 204) to an outcoupler (such as the outcoupler 210). In some display applications, the light is a collimated image, and the waveguide transfers and replicates the collimated image to the eye. In general, an incoupler and outcoupler each include, for example, one or more optical grating structures, including, but not limited to, reflective gratings, diffraction gratings, holograms, holographic optical elements (e.g., optical elements using one or more holograms), volume diffraction gratings, volume holograms, surface relief diffraction gratings, and/or surface relief holograms. In some embodiments, a given incoupler or outcoupler is a reflective grating (e.g., a reflective diffraction grating or a reflective holographic grating) that causes the incoupler or outcoupler to reflect light and to apply designed optical function(s) to the light during the reflection.

In the present example, the display light 206 received at the incoupler 204 is relayed to the outcoupler 210 via the waveguide 202 using TIR. The display light 206 is then output to the eye 212 of a user via the outcoupler 210. As described above, in some embodiments the waveguide 202 is implemented as part of an eyeglass lens, such as the lens 108 or lens 110 (FIG. 1) of the display system having an eyeglass form factor and employing the display system 200.

In this example implementation, the waveguide 202 implements facets in the region 208 (which provide exit pupil expansion functionality) and facets of the region 210 (which provide OC functionality) toward the world-facing side 207 of the waveguide 202 and the lens element 110, and the facets of the IC 204 are implemented toward the eye-facing side 205 of the lens element 110. Thus, under this approach, display light 206 from a light source 209 is incoupled to the waveguide 202 via the IC 204, and propagated (through total internal reflection in this example) toward the region 208, whereupon the facets of the region 208 reflect the incident display light for exit pupil expansion purposes, and the resulting light is propagated to the facets of the region 210, which output the display light toward a user's eye 212. In other embodiments, the facets of the IC 204 are implemented toward the world-facing side 207 of the lens element 110.

Embodiments of reflective waveguide structures formed according to the techniques described herein achieve uniform display quality with limited artifacts using reflective waveguide facets, as described further hereinbelow. For example, in some embodiments, the facets allow display light to travel through the facets from one surface of the waveguide to a different, opposing surface of the waveguide rather than, e.g., reflecting the light from one surface back onto the same surface. In some embodiments, as described further hereinbelow, the facets are formed to have a desired shape that enables this functionality.

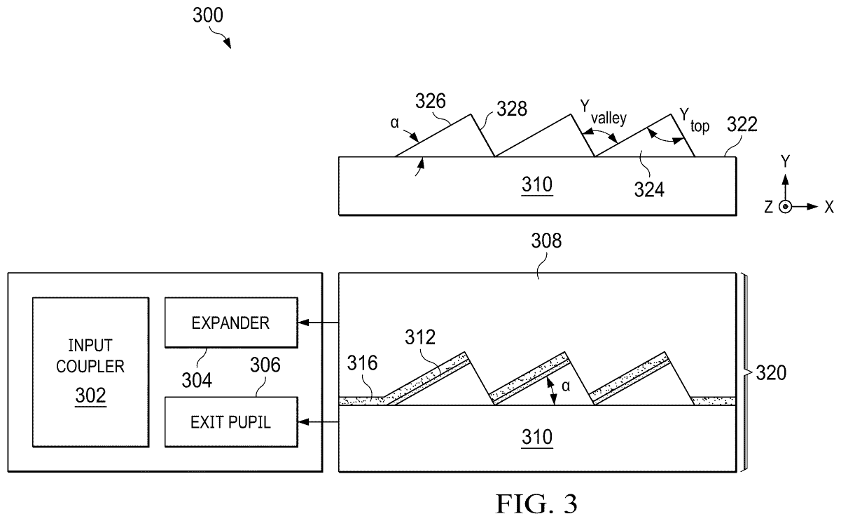

In some embodiments, a reflective waveguide consists of different areas depicted in FIG. 3, which illustrates a schematic diagram of a reflective waveguide 300 with two-dimensional pupil expansion geometry. The reflective waveguide 300 includes an input coupler 302 as well as an expander area 304 and exit pupil area 306 that utilize a specific prism array 320 with specific orientation and pitch. In some embodiments, the prism array 320 has variable height. In some embodiments, the surface of the prism array 320 is ultra flat and smooth, and the alignment is extremely tight. Current reflective waveguide eyepieces are typically fabricated by injection molding and limited to one-dimensional (1D) pupil expansion. The use of two-dimensional (2D) pupil expansion geometry carries even more stringent specifications for flatness, parallelism, and roughness, etc. For example, the prism array 320 includes a top prism array 308 and a bottom prism array 310. The top prism array 308 and bottom prism array 310 are fabricated separately by injection molding. The bottom prism array 310 is characterized by a top surface 322 on which a series of prism structures 324 are formed. Each of the prism structures 324 includes a primary surface 326 and a secondary surface 328. The primary surface 326 is disposed at an angle α with respect to the top surface 322 and at an angle γₜₒₚ with respect to the secondary surface of the prism structure 324. The primary surface 326 is disposed at an angle γ_{valley} with respect to the previous secondary surface 328 in the series. One or more reflective coatings 312 is selectively deposited on the facets (i.e., on the primary surfaces 326) of the bottom prism array 310. A precision bonding process using, e.g., a polymer glue 316 is then carried out to form the final waveguide.

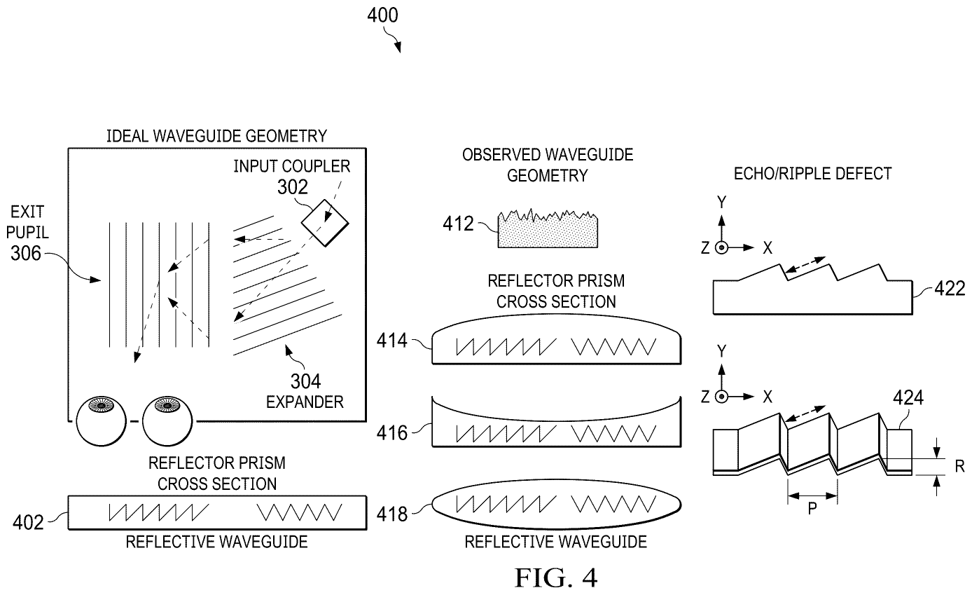

FIG. 4 is a diagram illustrating ideal waveguide geometry 400 in contrast to defects that can occur with injection molded reflective waveguides. The ideal waveguide geometry 400 exhibits perfect or near-perfect flatness, both in the grating surfaces and the outer major surfaces of the waveguide. For example, a cross section 402 of an ideal reflective waveguide includes prism facets that are ultra flat, as are the outer surfaces of the reflective waveguide as shown in cross section 402. However, due to material shrinkage that can occur during cooling of injection molded materials, observed waveguide geometry can differ from ideal waveguide geometry as shown in cross section 402 by exhibiting various peak to valley (PV) errors such as those illustrated in cross section 412, including concave and convex shapes such as those illustrated in cross sections 414,-416, and 418 and local echo or ripple defects such as those illustrated in cross sections 422 and 424.

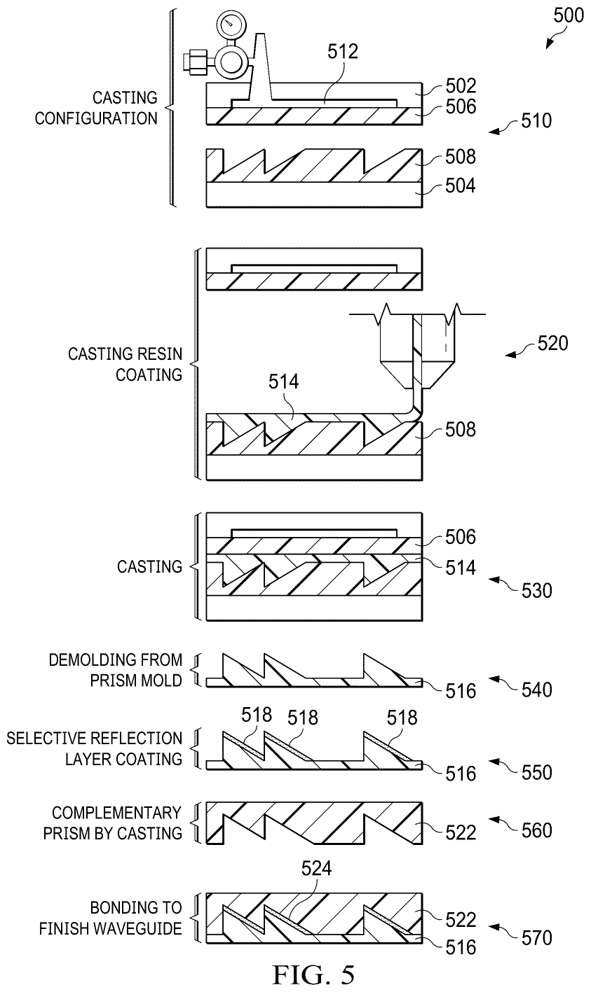

To minimize such defects, embodiments described herein employ a casting process. FIG. 5 is a diagram illustrating a process 500 for casting portions of a waveguide in accordance with some embodiments. The illustrated process begins with a first step 510 of preparing a casting configuration in which a set of ultra flat chucks (i.e., a top chuck 502 and a bottom chuck 504) hold a prism mold 508 and a flat surface used as a top flat mold 506, respectively. The top chuck 502 includes a cavity 512 that can be pressurized or vacuumed in some embodiments. The prism mold 508 is secured to the bottom chuck 504 with vacuum pressure in some embodiments.

In a second step 520, a casting resin 514 is coated on the bottom prism mold 508 via a technique such as inkjet, slot die, or spray coating, etc. In a third step 530, the top flat mold 506 is lowered to conform with the casting resin 514 and the casting resin 514 is then cured to form a bottom prism array 516. In some embodiments, the casting resin 514 is cured via ultraviolet (UV) or thermal curing or a combination thereof.

After curing, in a fourth step 540, the bottom prism array 516 is demolded from the prism mold 508 and the top flat mold 506. In a fifth step 550, the bottom prism array 516 is selectively coated with a reflective coating 518. For example, in some embodiments, selected faces of the facets formed on the surface of the bottom prism array 516 are coated with the reflective coating 518. In a sixth step 560, a top prism array 522 having a shape that complements the bottom prism array 516 is fabricated using similar steps to those used to form the bottom prism array 516. The top prism array 522 is then bonded to the bottom prism array 516 with an adhesive layer 524 in a seventh step 570.

In some embodiments, the top flat mold is an ultra-flat transparent substrate (e.g., having a total thickness variation that is less than 1 um). In some embodiments, the transparent substrate is composed of fused silica wafer. The top flat mold is used as a carrier wafer in some embodiments, and a wafer process is used for the remainder of the fabrication process with the top flat mold functioning as a carrier wafer.

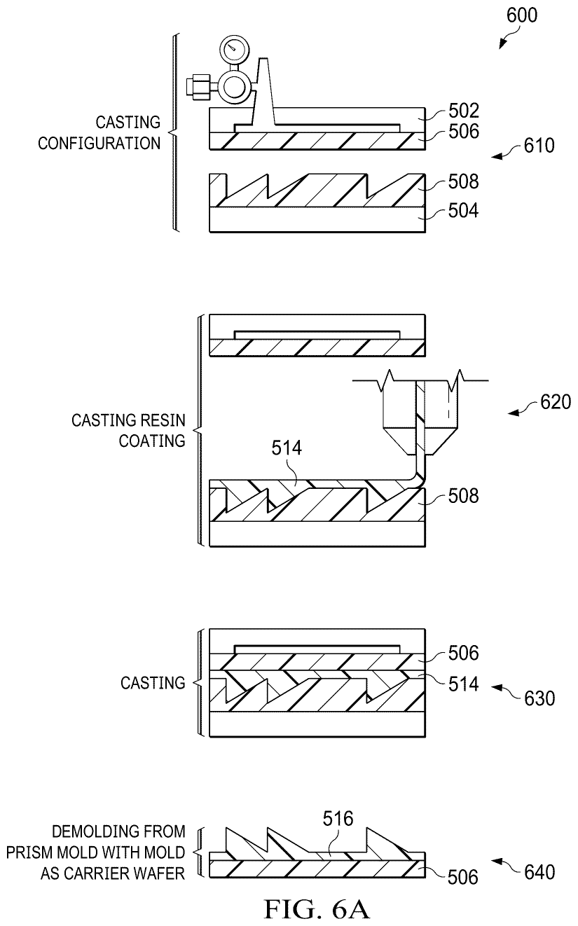

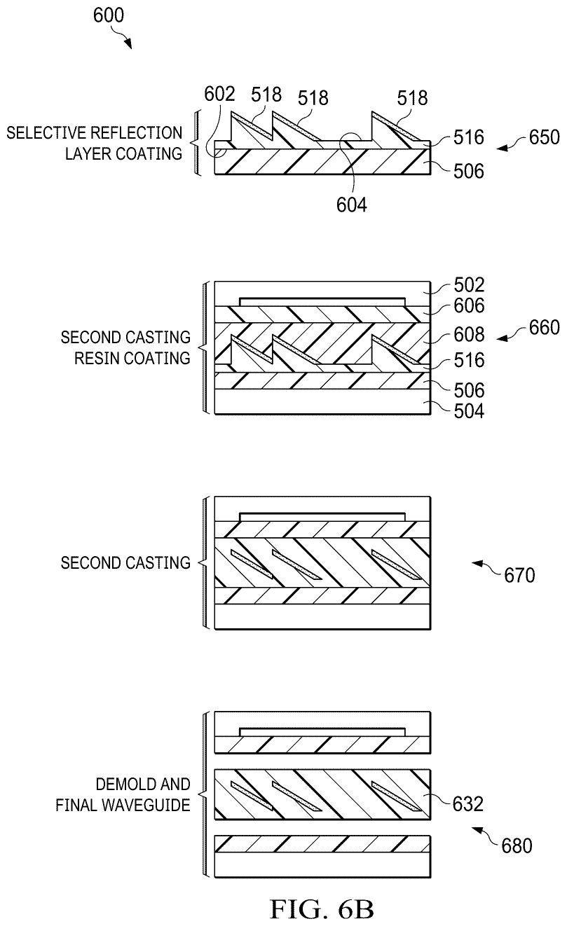

FIGS. 6A and 6B are diagrams illustrating consecutive casting processes for fabricating a waveguide using a top flat mold as a carrier wafer in accordance with some embodiments. Casting of the bottom prism mold proceeds as described above with respect to FIG. 5. Namely, at step 610, the ultra-flat top chuck 502 and the ultra-flat bottom chuck 504 are used to hold the bottom prism mold 508 and the top flat mold 506, respectively. At step 620, casting resin 514 is coated on the bottom prism mold 508 using inkjet, slot die, spray coating, or other methods. At step 630, the top flat mold 506 is lowered to conform to the casting resin 514 and the casting resin 514 is cured to form a bottom prism array 516. After the casting process, at step 640, the bottom prism array 516 is demolded only from the bottom prism mold 508. In some embodiments, the demolding process is performed by depositing different anti-sticking layers on the top flat mold 506 versus the bottom prism mold 508. For example, in some embodiments, trichloro(1H, 1H, 2H, 2H-perfluorooctyl)silane (FOTS) is deposited on the bottom prism mold 508 and perfluorodecyltrichlorosilane (FDTS) is deposited on the top flat mold 506. FOTS provides a better demolding force such that demolding will occur first from the FOTS-coated bottom prism mold 508 surface.

At step 650, the top flat mold 506 with the bottom prism array 516 is discharged and transferred to a wafer process tool for application of the reflective coating 518. Meanwhile, the bottom prism array 516 remains bonded to the top flat mold 506 such that the top flat mold 506 functions as a carrier wafer for the bottom prism array 516 and the flat major surface 602 of the bottom prism array 516 remains ultra flat. Using the top flat mold 506 as a carrier wafer reduces the complexity of prism handling for the remaining fabrication steps and also minimizes or even eliminates the formation of echoes or ripples (i.e., local thickness variation).

The prism array major surface 604 of the bottom prism array 516 is selectively coated with a reflective coating 518, after which, at step 660, the carrier wafer (i.e., the top flat mold 506) is loaded back to the casting tool, now on the bottom chuck 504. Another top flat mold 606 is loaded on the top chuck 502, and the casting process is repeated at step 670 in a second consecutive casting by applying to the prism array major surface 604 of the bottom prism array 516 the same casting resin 608 that was used to form the bottom prism array 516. Application of the casting resin 608 for the top prism array directly to the bottom prism array 516 ensures perfectly matched top and bottom prism array polymer parts without the need for an adhesive (glue) bonding process. After the second casting step 670, the final waveguide 632 is released (demolded) from the two top flat molds at step 680. The final waveguide 632 has uniform thickness, and minimal or no local thickness variation (echo/ripple) will be observed. In some embodiments, the base thickness of the top prism array layer is reduced to less than 100 um. In some implementations, after casting, the final waveguide 632 is polished to achieve a specified total thickness variation (TTV) and flatness. To homogenize the material properties and reduce undesired birefringence and stress, in some embodiments, the final waveguide 632 is post-annealed at a temperature T<Tg−10° C. for a time between approximately five minutes and two hours, where Tg is the glass transition temperature. A thin, uniformly thick final waveguide provides improved performance for AR applications.

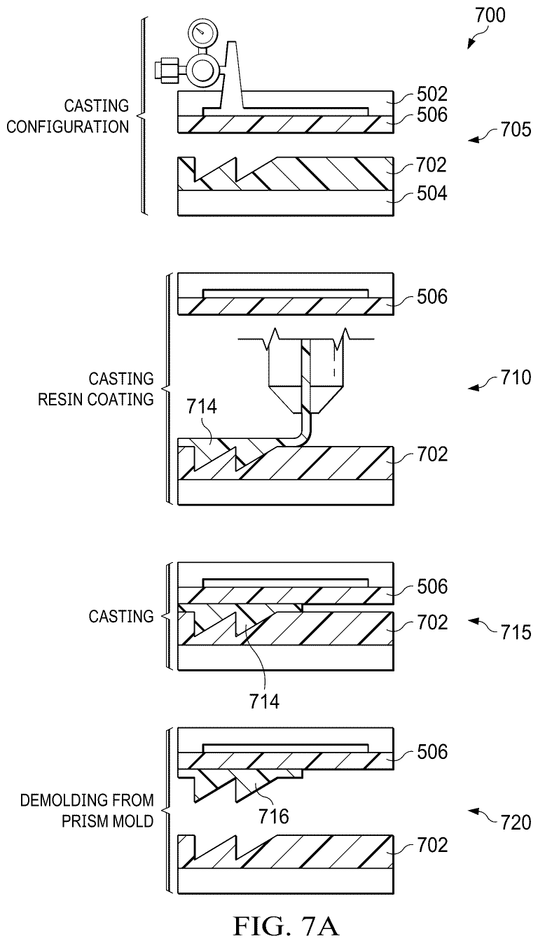

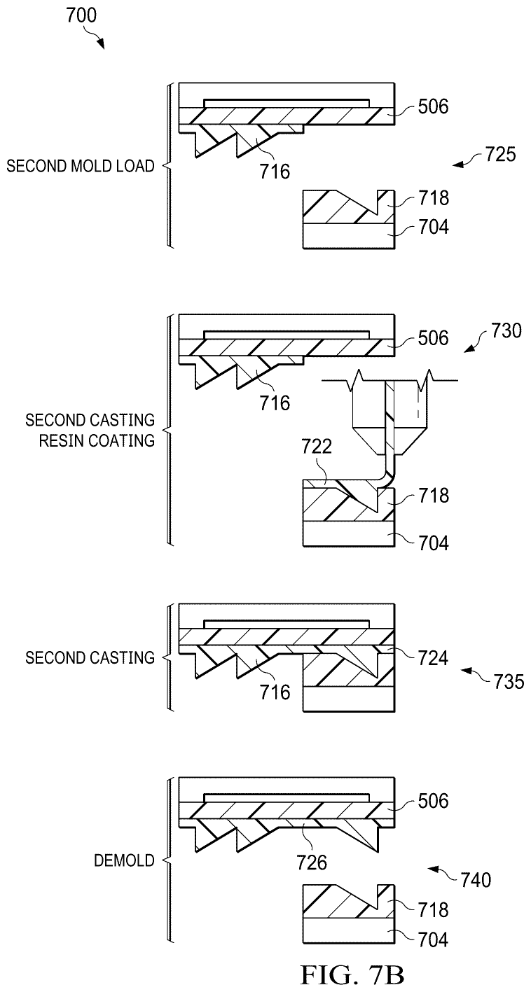

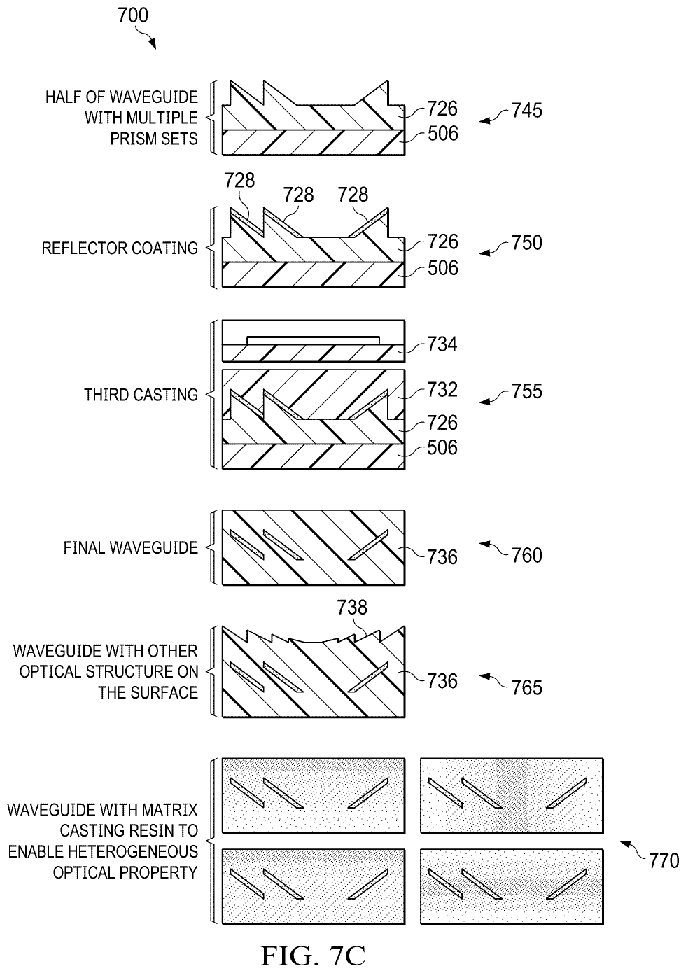

Using the carrier wafer casting process described above with respect to FIGS. 6A and 6B, the casting process can be carried out with the same product multiple times to implement various optical components. For example, FIGS. 7A, 7B, and 7C together illustrate a process 700 for implementing various different optical components on one waveguide using multiple consecutive casting steps. In some embodiments, the optical components are different prism arrays, and in other embodiments, the optical components are diffractive gratings, holographic optical elements, optical metamaterials, or other structures. In some embodiments, the optical components are used to perform functions such as incoupling light to the waveguide, exit pupil expansion within the waveguide, and outcoupling light from the waveguide toward the eye of a user when the waveguide is implemented in a display device.

A first optical component is fabricated using a first local casting as shown in steps 705, 710, 715, and 720. In step 705, a molding tool is configured for the casting process with a top chuck 502 holding a top flat mold 506 and a bottom chuck 504 holding a first bottom prism mold 702. In the illustrated example, the first bottom prism mold 702 includes prism structures that extend for only a portion of the length of the first bottom prism mold 702. Such a configuration, with the bottom chuck 504 holding the first bottom prism mold 702, is well suited to resin filling. However, in other embodiments, the molding tool is loaded with the top chuck 502 holding the first prism mold 702 and the bottom chuck 504 holding the flat mold 506.

In step 710, casting resin 714 is applied to the first bottom prism mold 702 using, e.g., inkjet, slot die, spray coating, or other methods. In step 715, the top flat mold 506 is lowered to conform to the casting resin 714 and the casting resin 714 is cured to form the first bottom prism array 716. In step 720, the first bottom prism array 716 is demolded (released) from the first bottom prism mold 702 and the top flat mold 506 is used as a carrier wafer for the first bottom prism array 716.

FIG. 7B illustrates a continuation of the process 700. Once the first bottom prism mold 702 has been removed, at step 725, a second bottom prism mold 718 is loaded onto a bottom chuck 704. In the illustrated example, the second bottom prism mold 718 and the bottom chuck 704 extend across the portion of the length of the first bottom prism mold 702 for which the first bottom prism mold 702 does not include prism structures. At step 730, a second casting resin 722 is locally coated on the second bottom prism mold 718 to form a second optical component 724. At step 735, a second casting is performed to add the second optical component 724 to the first bottom prism array 716. Thus, the use of the first bottom prism mold 702 and the second bottom prism mold 718 in the casting process 700 using the top flat mold 506 as a carrier wafer provides the flexibility to use prism structures from different molds in a single waveguide. At step 740 the first bottom prism array 716 and the second optical component 724 (which together form a first portion 726 of a reflective waveguide) are demolded (released) from the second bottom prism mold 718 such that all demolding occurs at the resin-to-bottom prism mold interface.

Turning to FIG. 7C, which illustrates a further continuation of the process 700, at step 745, the top flat mold 506 functions as a carrier wafer to temporarily hold various components (e.g., the first portion 726 of the reflective waveguide).

At step 750, after all components are patterned on the top flat mold 506, the first portion 726 of the reflective waveguide is unloaded and continues to the coating process, in which the facets of the first portion 726 of the reflective waveguide are selectively coated with a reflective coating 728. At step 755, a third (final) casting is performed using a top flat mold 734 to add a complementary second portion 732 of the reflective waveguide to the first portion 726 of the reflective waveguide, resulting in a final waveguide 736 in step 760. In some embodiments, the top flat mold 734 in step 755 is replaced with a featured mold (not shown) that enables formation of the waveguide 736 with an additional optical function on the surface of the waveguide 736. For example, in step 765 a Fresnel lens 738 is fabricated on top of the reflective waveguide 736 using a featured mold (not shown) in step 755 in place of the top flat mold 734.

In some embodiments, such as illustrated in step 770, the resin material used for casting is not limited to a homogeneous casting resin but could also be a matrix material, a mixture of various polymers, or a mixture of polymers with inorganic nanocrystals, etc. The loading/doping level of components of the mixture is tuned in some embodiments to create a refractive index gradient. In some embodiments, different materials are used in different areas of the reflective waveguide 736, for example, for the different components of the reflective waveguide 736 or to produce variable thickness between components of the reflective waveguide 736.

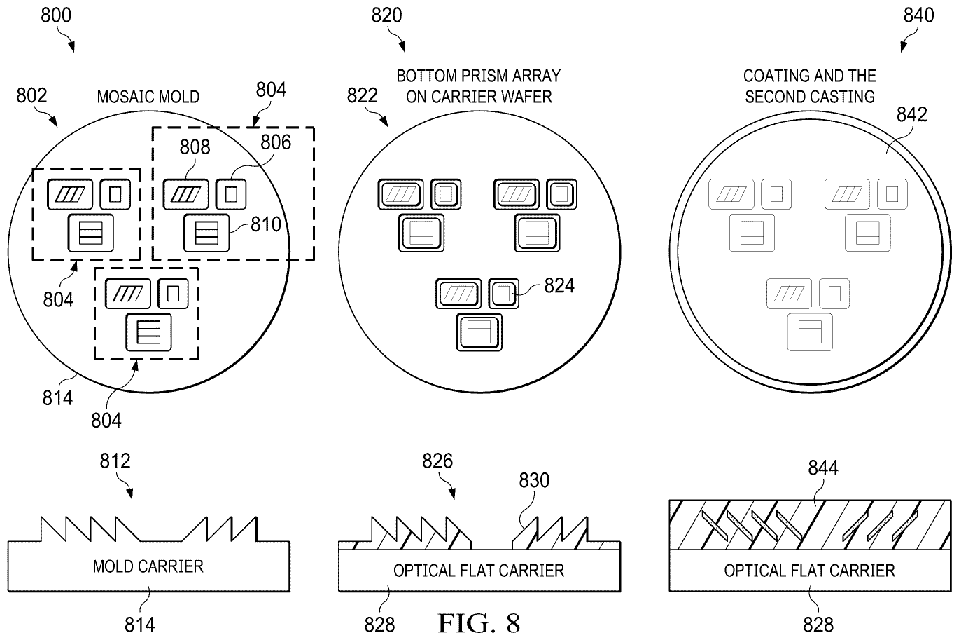

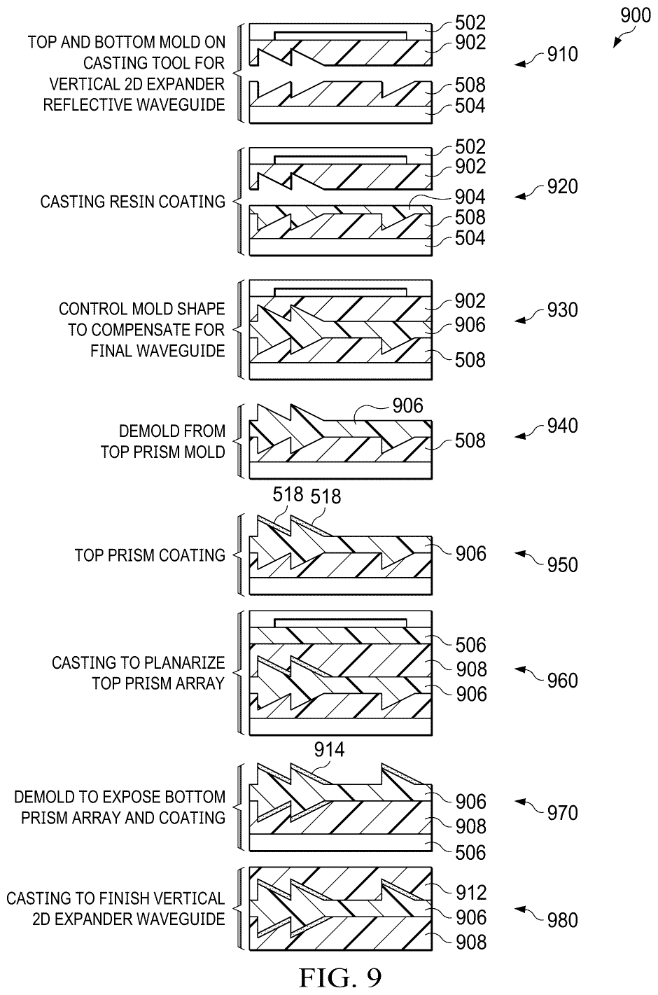

In some embodiments, multiple optical components can be fabricated on one waveguide using a composited (“Mosaic”) mold. FIG. 8 is a diagram illustrating a Mosaic casting mold and process. The Mosaic mold 800 includes multiple molds which are cut from one or more whole wafer molds to form a Mosaic mold 800 on a carrier substrate 814. In the illustrated example shown at FIG. 9-1, a top view 802 of the Mosaic mold 800 includes components for three waveguides 804, with each waveguide 804 including an incoupler component 806, an exit pupil expander component 808, and an outcoupler component 810. Dashed lines indicate the groupings of the components within the three waveguides 804. A cross section 812 of the Mosaic mold 800 on a mold carrier substrate 814 is depicted below the top view 802.

A two-step casting process using the Mosaic mold is illustrated in steps 820 and 840. In a first casting shown in top view 822, casting resin 824 is locally coated on the local molds as shown in step 820 to form casted prisms 830. As shown in a cross section 826, the casted prisms 830 remain supported by the top flat mold 828, which serves as a carrier, for selective application of reflective coating (not shown) to the casted prisms. In a second casting process illustrated in step 840, casting resin 842 is applied to cover the entire area of the three waveguides 804 to form ultra-flat complete waveguides 844. After the casting resin 842 has cured, the individual molds are singulated. Using a Mosaic mold 800 in a two-step casting process such as that illustrated at steps 820 and 840 can enable high-volume manufacturing of reflective waveguides.

In some embodiments, a reflective waveguide with multiple prism arrays to enable two-dimensional pupil expansion is implemented vertically (i.e., in a stacked configuration). FIG. 9 is a diagram of a process flow 900 to fabricate vertically stacked prism arrays. A vertical configuration can significantly reduce the form factor of the waveguide by, e.g., stacking an exit pupil expander and an outcoupler vertically rather than displacing the components laterally from each other as shown in the waveguides of FIG. 8. During the process flow illustrated in FIG. 9, molds with different prism arrays are chucked on both the top and bottom sides.

A first casting process shown in steps 910-940 fabricates both the top and bottom prism arrays simultaneously. Subsequent rounds of casting shown in steps 960-980 are performed to planarize the surfaces and finish the reflective waveguide.

At step 910, the molding tool is configured for the casting process with the top chuck 502 holding a top prism mold 902 and the bottom chuck 504 holding the bottom prism mold 508. In the illustrated example, the top prism mold 902 and the bottom prism mold 508 are used to fabricate a reflective waveguide having an incoupler and a vertical two-dimensional (2D) exit pupil expander to perform both exit pupil expansion and outcoupling of display light.

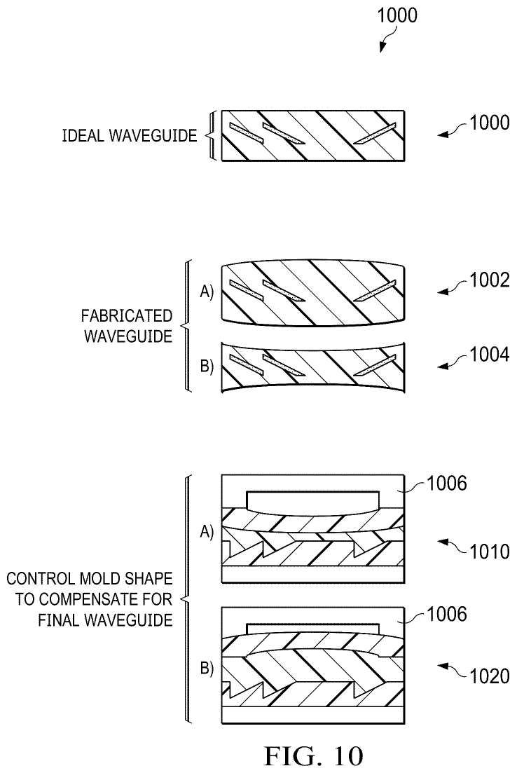

At step 920, resin coating 904 is cast in the cavity between the bottom prism mold 508 and the top prism mold 902. The resin coating 904 fills the cavity and is cured to produce a 2D (top and bottom) prism array 906. In some embodiments, and as explained further in reference to FIG. 10, at step 930 either positive pressure or negative pressure (vacuum) is applied to the top chuck 502 to control the mold shape to compensate for expansion or shrinkage of the 2D prism array 906.

At step 940, the 2D prism array 906 is demolded from the top prism mold 902. At step 950, the top prism surface of the 2D prism array 906 is selectively coated with a reflective coating 518. At step 960, a second casting is performed to planarize the top prism array. In the second casting, casting resin 908 is cast over the coated top prism surface of the 2D prism array 906. In some embodiments, the casting resin 908 is the same material as the casting resin 904.

At step 970, the bottom surface of the 2D prism array 906 is demolded from the bottom prism mold 508 to expose the bottom prism array for coating with a reflective coating 914. At step 980, a third casting is performed by casting a casting resin 912 over the bottom prism array to planarize the bottom prism array. In some embodiments, the casting resin 912 is the same material as the casting resin 904.

FIG. 10 is a diagram illustrating differences between an ideal waveguide 1000 and a fabricated waveguide, such as fabricated waveguides 1002, 1004, and a method of compensating for the differences in accordance with some embodiments. To enable a high-quality waveguide, the flatness and parallelism between the top and bottom surfaces must be sufficiently high. Ideally, the two surfaces should be perfectly flat and parallel, as shown in ideal waveguide 1000. However, due to material shrinkage, a fabricated waveguide can have a different thickness at the center than at the edges, resulting in either a concave shape, as shown in fabricated waveguide 1002, or a convex shape, as shown in fabricated waveguide 1004. A casting process using positive or negative (i.e., vacuum) pressure can be used to modulate the resin thickness before the curing process to compensate for the final thickness due to shrinkage.

For example, to compensate for the concave shape fabricated waveguide 1002, pressure is applied to the top flat chuck 1006 during casting and before curing, as shown at step 1010. The top flat of the concave fabricated waveguide 1002 will bow in a controllable way, resulting in a thinner thickness at the center such that the finished waveguide has a uniform thickness throughout. To compensate for a convex shape, as shown in fabricated waveguide 1004, vacuum is applied to the top flat chuck 1006 in a feedback-controlled loop, as shown at step 1020. The feedback-controlled loop is applied in some embodiments to create a customized waveguide profile, such as a particular total thickness variation (TTV) shape (e.g., a dome shaped TTV or a wedge shaped TTV). Further, the range of TTV can be varied in a controllable way. The feedback-controlled loop fabrication method can be used to generate waveguides having a customized curvature to enable various optical functions such as lens power in some embodiments.

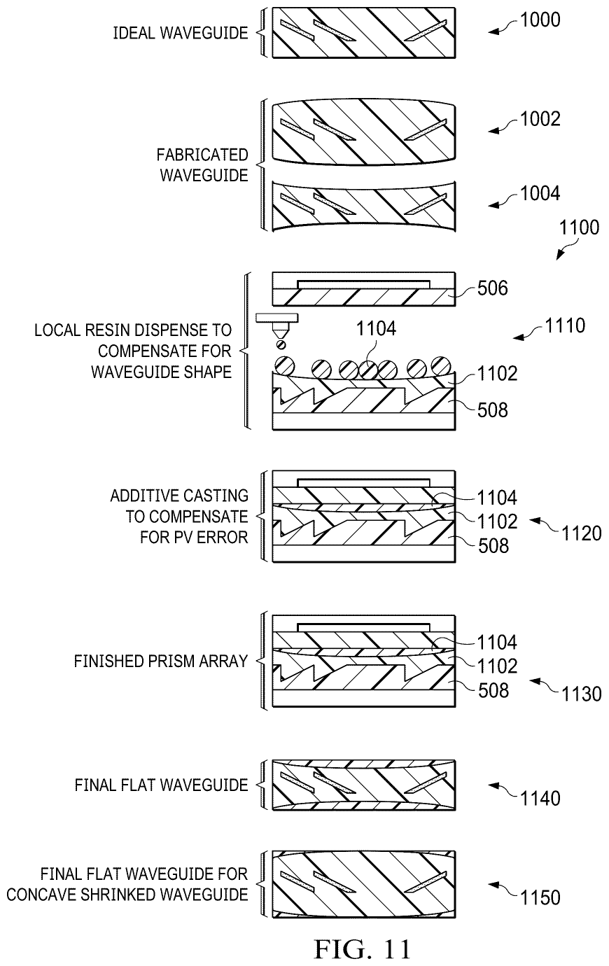

In some embodiments, a casting process is applied to correct a peak-to-valley (PV) error in a fabricated reflective waveguide. FIG. 11 is a diagram of a process flow 1100 to correct a center-to-edge PV error using a casting process in accordance with some embodiments. Whereas an ideal waveguide 1000 has perfectly flat and parallel outer surfaces, a fabricated waveguide may have a center-to-edge PV error that can be as large as several micrometers, as shown in fabricated waveguides 1002, 1004. To compensate for the PV error, a local casting resin coating process such as inject coating or spray coating is applied to the concave surface of a bottom prism array 1102, as shown in step 1110. In the illustrated example, a higher volume of casting resin 1104 is coated at the center (thinner) area of the concave surface of the bottom prism array 1102 than at the edges of the concave surface of the bottom prism array 1102 to match the thickness difference from center to edge. In some embodiments, the difference in the volume of casting resin 1104 at the center versus the edges of the concave surface matches or is proportional to the thickness difference across the diameter of the fabricated waveguide 1004 to compensate for the TTV. At step 1120, the top flat mold 506 is lowered to conform to the additive casting resin 1104 and the casting resin 1104 is cured to form a bottom prism array 1102 having a flat major surface. At step 1130, the bottom prism array 1102 is demolded (released) from the bottom prism mold 508. Steps 1110-1130 are repeated as necessary to correct any TTV in the top half of the fabricated waveguide to produce a final flat waveguide 1140.

To correct TTV of a convex fabricated waveguide such as fabricated waveguide 1002, a similar process is applied, except a higher volume of casting resin 1104 is coated at the edges of the convex surface of the prism array than at the center. The additive resin 1104 is cured to produce a flat waveguide 1150. This local additive manufacturing method can be applied to create a customized waveguide profile, such as a particular TTV shape (e.g., a dome shaped TTV or a wedge shaped TTV). The range of TTV can be varied in a controlled way to generate customized waveguide curvatures to enable optical functions such as lens power in some embodiments.

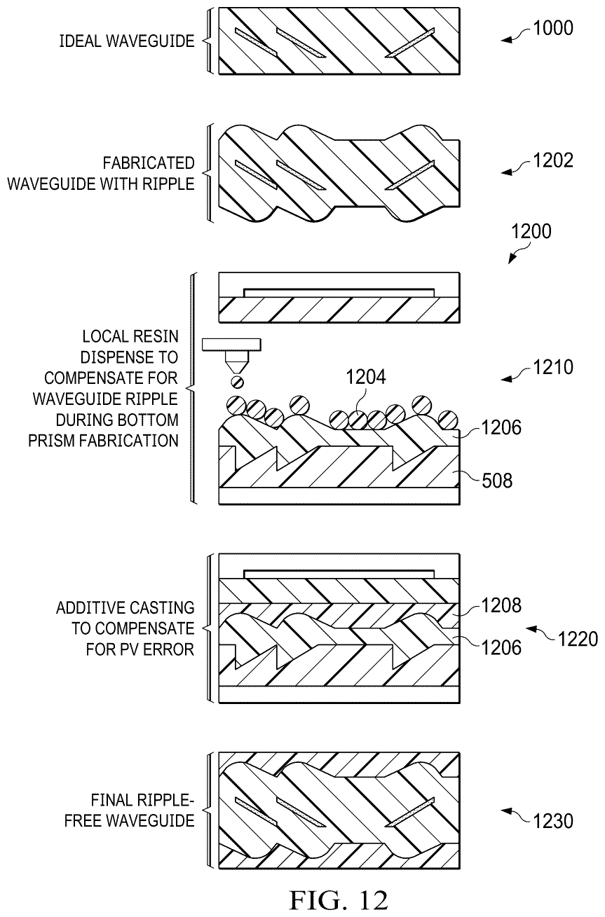

In some embodiments, a casting process is applied to correct an echo/ripple error. FIG. 12 is a diagram illustrating a process 1200 to correct an echo/ripple error using a casting process in accordance with some embodiments. Whereas an ideal waveguide 1000 has perfectly flat and parallel outer surfaces, a fabricated waveguide 1202 may exhibit an echo error that can be as large as several micrometers. To compensate for the echo/ripple error, a local casting resin coating process 1200 such as inject coating or spray coating is applied, as shown in steps 1210 and 1220. In the illustrated example, at step 1210, additive resin 1204 is dispensed locally to compensate for ripples in the outer surface of the waveguide during fabrication of the bottom prism array 1206. The coating volume can be adjusted locally to compensate for the echo error. The resin is then cured, as shown at step 1220, to produce a flat waveguide 1230.

In some embodiments, certain aspects of the techniques described above may be implemented by one or more processors of a processing system executing software. The software comprises one or more sets of executable instructions stored or otherwise tangibly embodied on a non-transitory computer readable storage medium. The software can include the instructions and certain data that, when executed by the one or more processors, manipulate the one or more processors to perform one or more aspects of the techniques described above. The non-transitory computer readable storage medium can include, for example, a magnetic or optical disk storage device, solid state storage devices such as Flash memory, a cache, random access memory (RAM) or other non-volatile memory device or devices, and the like. The executable instructions stored on the non-transitory computer readable storage medium may be in source code, assembly language code, object code, or other instruction format that is interpreted or otherwise executable by one or more processors.

A computer readable storage medium may include any storage medium, or combination of storage media, accessible by a computer system during use to provide instructions and/or data to the computer system. Such storage media can include, but is not limited to, optical media (e.g., compact disc (CD), digital versatile disc (DVD), Blu-Ray disc), magnetic media (e.g., floppy disk, magnetic tape, or magnetic hard drive), volatile memory (e.g., random access memory (RAM) or cache), non-volatile memory (e.g., read-only memory (ROM) or Flash memory), or microelectromechanical systems (MEMS)-based storage media. The computer readable storage medium may be embedded in the computing system (e.g., system RAM or ROM), fixedly attached to the computing system (e.g., a magnetic hard drive), removably attached to the computing system (e.g., an optical disc or Universal Serial Bus (USB)-based Flash memory), or coupled to the computer system via a wired or wireless network (e.g., network accessible storage (NAS)).

Note that not all of the activities or elements described above in the general description are required, that a portion of a specific activity or device may not be required, and that one or more further activities may be performed, or elements included, in addition to those described. Still further, the order in which activities are listed are not necessarily the order in which they are performed. Also, the concepts have been described with reference to specific embodiments. However, one of ordinary skill in the art appreciates that various modifications and changes can be made without departing from the scope of the present disclosure as set forth in the claims below. Accordingly, the specification and figures are to be regarded in an illustrative rather than a restrictive sense, and all such modifications are intended to be included within the scope of the present disclosure.

Benefits, other advantages, and solutions to problems have been described above with regard to specific embodiments. However, the benefits, advantages, solutions to problems, and any feature(s) that may cause any benefit, advantage, or solution to occur or become more pronounced are not to be construed as a critical, required, or essential feature of any or all the claims. Moreover, the particular embodiments disclosed above are illustrative only, as the disclosed subject matter may be modified and practiced in different but equivalent manners apparent to those skilled in the art having the benefit of the teachings herein. No limitations are intended to the details of construction or design herein shown, other than as described in the claims below. It is therefore evident that the particular embodiments disclosed above may be altered or modified and all such variations are considered within the scope of the disclosed subject matter. Accordingly, the protection sought herein is as set forth in the claims below.

What is claimed is:

1. A method, comprising:
casting a first material between a first prism mold and a first flat mold to form a first portion of a reflective waveguide;
demolding the first portion of the reflective waveguide from the first prism mold;
selectively coating the first portion of the reflective waveguide with a reflective coating;
casting a second material over the first portion of the reflective waveguide; and
supporting the first portion of the reflective waveguide with the first flat mold during selectively coating and casting the second material.

2. The method of claim 1, further comprising:
curing the first material to form the first portion of the reflective waveguide.

3. The method of claim 1, further comprising:
curing the second material to form the reflective waveguide.

4. The method of claim 1, wherein casting the second material comprises casting the second material between the first portion of the reflective waveguide and a second flat mold.

5. The method of claim 4, wherein casting the second material comprises casting the second material between the first portion of the reflective waveguide and a first featured mold.

6. The method of claim 1, wherein casting the second material comprises casting the second material between the first portion of the reflective waveguide and a second prism mold.

7. The method of claim 1, wherein the first material and the second material are the same material.

8. The method of claim 1, further comprising:
casting a third material between a second prism mold and the first flat mold to form a second portion of the reflective waveguide.

9. The method of claim 1, wherein the first prism mold comprises a Mosaic mold comprising multiple molds on a carrier substrate.

10. The method of claim 1, further comprising:
applying pressure to a chuck holding the first flat mold to compensate for thickness variation of the reflective waveguide.

11. The method of claim 1, further comprising:
locally casting a third material over an outer surface of the reflective waveguide to compensate for thickness variation of the reflective waveguide.

12. A reflective waveguide, comprising:
a first prism array comprising a first material cast and cured between a first flat mold and a first prism mold;
a reflective coating on facets of the first prism array; and
a second material cast and cured over the first prism array while the first prism array is supported by the flat mold.

13. The reflective waveguide of claim 12, wherein the second material is cast and cured between the first prism array and a second flat mold.

14. The reflective waveguide of claim 12, wherein the second material is cast and cured between the first prism array and a featured mold.

15. The reflective waveguide of claim 12, wherein the second material is cast and cured between the first prism array and a second prism mold.

16. The reflective waveguide of claim 12, wherein the first material and the second material are the same material.

17. The reflective waveguide of claim 12, wherein the first prism array comprises a plurality of optical components formed by casting and curing the first material on a Mosaic mold.

18. The reflective waveguide of claim 12, further comprising:
a third material locally cast and cured on an outer surface of the reflective waveguide to compensate for thickness variation of the reflective waveguide.

19. A method comprising:
casting a first material between a first prism mold and a first flat mold to form a first portion of a reflective waveguide;
supporting the first portion of the reflective waveguide with the first flat mold; and
casting a second material over the first portion of the reflective waveguide while the first portion of the reflective waveguide is supported by the first flat mold.

20. The method of claim 19, further comprising:
applying pressure to a chuck holding the first flat mold to compensate for thickness variation of the reflective waveguide.

21. The method of claim 19, further comprising:
post-annealing the reflective waveguide at a temperature less than the glass transition temperature minus 10° C. for a time between approximately five minutes and two hours.
